(19) United States
(12) Patent Application Publication
(10) Pub. No.: US 2024/0127223 A1
(43) Pub. Date: Apr. 18, 2024

(54) SYSTEMS AND METHODS FOR LINKING MULTIPLE DATA RECORDS TO A SINGLE TOKENIZED IDENTIFIER

(71) Applicant: MASTERCARD INTERNATIONAL INCORPORATED, Purchase, NY (US)

(72) Inventors: Zayna Francis, Norwalk, CT (US); Simon R. Dix, O'Fallon, MO (US)

(21) Appl. No.: 17/967,789

(22) Filed: Oct. 17, 2022

(51) Int. Cl. G06Q 20/36; G06Q 20/38

(52) U.S. Cl. CPC G06Q 20/363; G06Q 20/382

(57) ABSTRACT

Systems and methods for linking a plurality of data records to a tokenized identifier such that each data record is accessible via the tokenized identifier are disclosed. A first data record associated with a first account and a second data record associated with a second account may be loaded into a digital wallet. Next, a token primary account number (PAN) may be generated and linked to the first account and the second account. Available prepaid funds associated with the first account may be verified and displayed on a user interface. In response to an initiation of a transaction, an optimal payment structure based on the available funds of the first account may be determined. In response to authorization of the transaction from the issuing banks associated with the first account and the second account, an authorization message may be sent to a bank associated with the token PAN.

### BACKGROUND

This disclosure relates generally to electronic payment networks, and, more particularly, to systems and methods for linking a plurality of data records to a tokenized identifier such that each data record is accessible via the tokenized identifier.

In some cases, it may be helpful to associate data of one data record with data of another data record. However, creating and managing these associations may be difficult to do. In the payment industry, for example, prepaid cards may offer a more convenient and safer payment option than cash. Such payment cards are a prevalent form of payment among consumers. Thus, it is common that a person possess multiple payment cards that may be associated with different merchants and/or different payment networks. These payment cards are each associated with a data record that may include an account number, a merchant identifier, a payment processor identifier, a value amount assigned to the payment card, etc.

Since a user may possess multiple prepaid cards that are restricted as to what merchant they can be used with and because these cards typically have low values assigned to them, these cards oftentimes go unused or at the very least, are inconvenient for the user. Specifically, the user has to carry multiple low dollar cards around with them, the user has to remember to bring the cards with them to the specific merchant, or the cards simply go unused. Further, if the consumer would like to use their prepaid cards as payment tender in a transaction, the consumer must split the transaction into two or more transactions (i.e., perform a split sale) with the merchant whereby multiple cards are used in separate partial transactions to use the value available on each prepaid card. Not only is this burdensome to the consumer and the merchant, split sales extend checkout times, which is in no one's interest. Further, some merchants do not support split sales, forcing the consumer to use each of their prepaid cards in different transactions. Finally, prepaid cards typically are not eligible for payment tokens and their corresponding security capabilities. Tokenization is the process of protecting sensitive data by replacing it with an algorithmically generated number, i.e., a token, which helps prevent fraud. The inability to tokenize prepaid card may allow fraudulent transactions to successfully proceed.

As such, there is a need for improved methods and systems for linking the data records of each payment card with a single tokenized account identifier that can be used instead of the individual cards.

### BRIEF DESCRIPTION

In one aspect, a computer-implemented method for linking multiple data records to a single tokenized identifier is provided. The method is implemented using a computing system including at least one processor and a memory device. The method includes steps performed by the at least one processor including receiving a first data record associated with a first account into a digital wallet and a second data record associated with a second account into the digital wallet, wherein the first account is associated with a prepaid card. The steps also include generating a token primary account number (PAN) and linking the first data record and the second data record, sending an inquiry message to a first bank associated with the first account to verify available funds of the first account, and causing to be displayed on a user interface, the available funds of the first account. The steps further include, in response to initiation of a transaction, determining an optimal payment structure based on the available funds of the first account, and sending a first authorization request to a first bank associated with the first account and a second authorization request to a second bank associated with the second account based on the optimal payment structure. The steps further include, in response to authorization of the transaction from the first bank and the second bank, sending an authorization message to a bank associated with the token PAN.

In another aspect, a computing system for linking multiple data records to a single tokenized identifier is provided. The computing system includes at least one processor and a memory device. The computing system may further comprise a display device. The at least one processor is programmed to perform steps including receiving a first data record associated with a first account into a digital wallet and a second data record associated with a second account into the digital wallet, wherein the first account is associated with a prepaid card. The steps also include generating a token primary account number (PAN) and linking the first data record and the second data record, sending an inquiry message to a first bank associated with the first account to verify available funds of the first account, and causing to be displayed on a user interface, the available funds of the first account. The steps further include, in response to initiation of a transaction, determining an optimal payment structure based on the available funds of the first account, and sending a first authorization request to a first bank associated with the first account and a second authorization request to a second bank associated with the second account based on the optimal payment structure. The steps further include, in response to authorization of the transaction from the first bank and the second bank, sending an authorization message to a bank associated with the token PAN.

In another aspect, at least one non-transitory computer-readable medium including instructions stored thereon for linking multiple data records to a single tokenized identifier is provided. The instructions are executable by at least one processor to cause the at least one processor to perform steps including receiving a first data record associated with a first account into a digital wallet and a second data record associated with a second account into the digital wallet, wherein the first account is associated with a prepaid card. The steps also include generating a token primary account number (PAN) and linking the first data record and the second data record, sending an inquiry message to a first bank associated with the first account to verify available funds of the first account, and causing to be displayed on a user interface, the available funds of the first account. The steps further include, in response to initiation of a transaction, determining an optimal payment structure based on the available funds of the first account, and sending a first authorization request to a first bank associated with the first account and a second authorization request to a second bank associated with the second account based on the optimal payment structure. The steps further include, in response to authorization of the transaction from the first bank and the second bank, sending an authorization message to a bank associated with the token PAN.

### BRIEF DESCRIPTION OF THE DRAWINGS

FIGS. 1-8 show example embodiments of the methods and systems described herein.

FIG. 1 is a schematic diagram illustrating an example risk-based authentication (RBA) platform in communication with a multi-party payment card system for processing payment transactions in accordance with one embodiment of the present disclosure.

FIG. 2 is an expanded block diagram of an example embodiment of a computer system used in processing payment transactions that includes a server system in accordance with one example embodiment of the present disclosure.

FIG. 3 illustrates an example configuration of a server system such as the server system shown in FIG. 2.

FIG. 4 illustrates an example configuration of a client system shown in FIG. 2.

FIG. 5 is a flow diagram of a first example method for linking multiple data records to a single tokenized identifier.

FIG. 6 is a diagram illustrating a first user display associated with the first example method of FIG. 5.

FIG. 7 is a flow diagram of a second example method for linking multiple data records to a single tokenized identifier.

FIG. 8 is a diagram illustrating a second user display associated with the second example method of FIG. 7.

Although specific features of various embodiments may be shown in some drawings and not in others, this is for convenience only. Any feature of any drawing may be referenced and/or claimed in combination with any feature of any other drawing.

### DETAILED DESCRIPTION

The following detailed description illustrates embodiments of the disclosure by way of example and not by way of limitation. The description clearly enables one skilled in the art to make and use the disclosure, describes several embodiments, adaptations, variations, alternatives, and uses of the disclosure, including what is presently believed to be the best mode of carrying out the disclosure.

The systems and methods described herein are directed to linking multiple data records to a single tokenized identifier. More specifically, disclosed herein are systems and methods for linking the data records of multiple payment cards with a single tokenized account identifier such that the single tokenized account may be used instead of the individual cards.

First, a data record may be inputted into a digital wallet. The data record may be associated with a payment card, such as a prepaid card. The prepaid card may be associated with a merchant and/or a payment processing company, such as MASTERCARD®. In some embodiments, the digital wallet may be an application on a portable device, such as a smartphone. Additionally, or alternatively, the digital wallet may be stored on a computer, such as a desktop computer. In some embodiments, the inputting may comprise taking a photograph of the payment card and storing the photograph in a digital wallet. Additionally, or alternatively, the inputting may comprise manually inputting a code or other data into the digital wallet. In some embodiments, the data record may include the amount or value of a payment card, whether the payment card is tied to one or more merchants or payment processors, and/or whether there are any predefined rules associated with card. In some embodiments, the predefined rules may be determined based on a lookup or application programming interface (API) call to a rules database. If there are predefined rules associated with the payment card, the predefined rules are retrieved upon initiation of the transaction so the system may determine whether the payment card may be used to perform the transaction.

Once the data record is inputted into the digital wallet, the digital wallet may generate a tokenized account number or token primary account number (PAN). The token PAN may represent an actual account number that can be used to initiate a payment card transaction. The token PAN may provide a secure transaction in that it does not expose the actual account number to data breaches and fraudsters, as it is tokenized and payment tokens benefit from token domain restriction controls. The token PAN may then be linked to the one or more payment cards that are inputted into the wallet. Stated another way, when the token PAN is used to initiate a payment transaction, the token PAN may be transmitted to complete the payment. The token PAN may be linked to the back end of each of the payment cards and configured to use one or more of the payment cards linked to the token PAN to complete the purchase.

Once a data record is inputted, it may be displayed in a digital wallet application or website. In some embodiments, the display will show a user how the amount or value associated with the respective payment card, whether the payment card is tied to a merchant or payment processor, and/or if there are any predefined rules or other parameters associated with the payment card (e.g., loyalty points, expiration date, etc.). In some embodiments, a user may be able to activate and deactivate payment cards in the digital wallet. If a payment card is activated, the payment card may be used if all rules are satisfied for use in a transaction. If a payment card is deactivated, the payment card may not be used, even if all rules are satisfied for use in a transaction.

In some embodiments, when a data record associated with a payment card is inputted into the digital wallet, any prepaid funds associated with the payment card is immediately accessed and moved to an account associated with the token PAN, such that the prepaid funds are immediately secured in an account associated with the user.

In other embodiments, an inquiry message is immediately sent when a data record associated with a payment card is inputted into the digital wallet. The inquiry message may verify the amount of prepaid funds available, that data record associated with the payment card has not been compromised, etc.

The token PAN may include additional fraud detection services associated with or used for each transaction with the token PAN that cannot be performed with prepaid cards on their own. For example, if the token PAN is used multiple times to initiate multiple transactions, the metadata associated with each transaction, such as device data, IP address, shipping address, etc., may all be stored and used to compare to other transactions. The system may determine a likelihood of fraud based on risk-based authentication (RBA) and/or risk based decisioning (RBD). For example, if the metadata associated with a transaction matches that of a user, the system may determine that those transactions are likely not a result of fraud, i.e., the user that is likely the legitimate cardholder is initiating the transaction. The transaction may then be performed with no further authentication steps, such as challenge questions, verification codes, etc. However, if the metadata does not match that of a user (e.g., an IP address that is not associated with the user, the transaction is being initiated in a different country than the location of the transaction), then the RBA/RBD module may score this transaction as a strong likelihood of fraud and in some instances be denied by the system. A message may be sent to the merchant and/or issuer to deny the transaction. The ability to monitor the token PAN and apply an RBA/RDL module to transactions dramatically improves the likelihood that a transaction is being performed by the legitimate cardholder and is not fraudulent.

A transaction may be initiated by submitting the token PAN. An authorization message may then be created and include the token PAN, as well as other data, such as the merchant ID, the product amount, etc., along with metadata. The system may then retrieve and apply predefined rules associated with the merchant ID. The authorization message may then be sent to a payment processor. The payment processor may identify that the token PAN is being used and in some cases may determine that the transaction needs to be split between a first account and a second account, where the first account is associated with a prepaid card. The payment processor may then determine an optimal way to structure the transaction (i.e., use the entire amount or value of a prepaid card and then pay for the remaining balance using the second account). The payment processor may save how the transaction was structured as a data record in the memory. A first message may be sent to a first bank associated with the first account and a second message may be sent to a second bank associated with the second account. Once the two banks authorize the transaction, the payment processor then sends an authorization message to the bank associated with the token PAN so the merchant bank knows to complete the transaction, and the transaction is then finalized.

The technical problems addressed by the system and associated methods of the disclosure include at least one of: (i) high network load associated with sending multiple authorization messages to a merchant in a split sale, which results in network delays and reduced bandwidth; (ii) inability to apply fraud detection services to prepaid cards, thereby enabling fraudulent transactions to successfully proceed; (iii) issuers having limited access to data that may be used to detect fraud; (iv) decreased speed of the authorization process in split sale due to great number of required messages; and (v) complexity associated with managing linked payment cards.

A technical effect of the system and associated methods of the disclosure are achieved by steps including one or more of: receiving a first data record associated with a first account into a digital wallet and a second data record associated with a second account into the digital wallet, wherein the first account is associated with a prepaid card; generating a token primary account number (PAN) and linking the first data record and the second data record; sending an inquiry message to a first bank associated with the first account to verify available funds of the first account; causing to be displayed on a user interface, the available funds of the first account; in response to initiation of a transaction, determining an optimal payment structure based on the available funds of the first account, and sending a first authorization request to a first bank associated with the first account and a second authorization request to a second bank associated with the second account based on the optimal payment structure; and in response to authorization of the transaction from the first bank and the second bank, sending an authorization message to a bank associated with the token PAN.

A technical effect of the system and associated methods of the disclosure include at least one of: (i) reducing network load by reducing number of authorization messages; (ii) ability to apply fraud detection services to prepaid cards, thereby preventing fraudulent transactions from successfully proceeding; (iii) enabling issuers to have access to data that may be used to detect fraud; (iv) increasing the speed of the authorization process by reducing the total number of messages required; and (v) reducing the complexity managing linked payment cards.

The following detailed description of the embodiments of the disclosure refers to the accompanying drawings. The same reference numbers in different drawings may identify the same or similar elements. Also, the following detailed description does not limit the claims.

Described herein are computer systems such as payment computer systems. As described herein, all such computer systems include a processor and a memory. However, any processor in a computer device referred to herein may also refer to one or more processors wherein the processor may be in one computing device or a plurality of computing devices acting in parallel. Additionally, any memory in a computer device referred to herein may also refer to one or more memories wherein the memories may be in one computing device or a plurality of computing devices acting in parallel.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the term “database” may refer to either a body of data, a relational database management system (RDBMS), or to both. As used herein, a database may include any collection of data including hierarchical databases, relational databases, flat file databases, object-relational databases, object oriented databases, and any other structured collection of records or data that is stored in a computer system. The above examples are example only, and thus are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

In one embodiment, a computer program is provided, and the program is embodied on a non-transitory computer readable medium. In an example embodiment, the system is executed on a single computer system, without requiring a connection to a sever computer. In a further embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Cisco Systems, Inc. located in San Jose, CA). In yet a further embodiment, the system is run on a Mac OS® environment (Mac OS is a registered trademark of Apple Inc. located in Cupertino, CA). In still yet a further embodiment, the system is run on Android® OS (Android is a registered trademark of Google, Inc. of Mountain View, CA). In another embodiment, the system is run on Linux® OS (Linux is a registered trademark of Linus Torvalds of Boston, MA). The application is flexible and designed to run in various different environments without compromising any major functionality. In some embodiments, the system includes multiple components distributed among a plurality of computing devices. One or more components may be in the form of computer-executable instructions embodied in a computer-readable medium.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

As used herein, the term “payment account” includes payment card accounts, bank accounts, stored valued accounts, mobile wallets, etc., and “payment card” refers to any suitable transaction card, such as a credit card, a debit card, a prepaid card, a charge card, a membership card, a promotional card, a frequent flyer card, an identification card, a prepaid card, a gift card, and/or any other device that may hold payment account information, such as mobile phones, smartphones, personal digital assistants (PDAs), wearable computing devices, key fobs, and/or any other computing devices capable of providing account information. Moreover, “payment cards” are not limited to physical devices but rather refer generally to payment credentials. In addition, consumer account behavior can include but is not limited to purchases, management activities (e.g., balance checking), bill payments, achievement of targets (meeting account balance goals, paying bills on time), and/or product registrations (e.g., mobile application downloads).

The systems and processes are not limited to the specific embodiments described herein. In addition, components of each system and each process can be practiced independent and separate from other components and processes described herein. Each component and process also can be used in combination with other assembly packages and processes.

The following detailed description illustrates embodiments of the disclosure by way of example and not by way of limitation. It is contemplated that the disclosure has general application to authenticating users for transactions conducted over an electronic payment network.

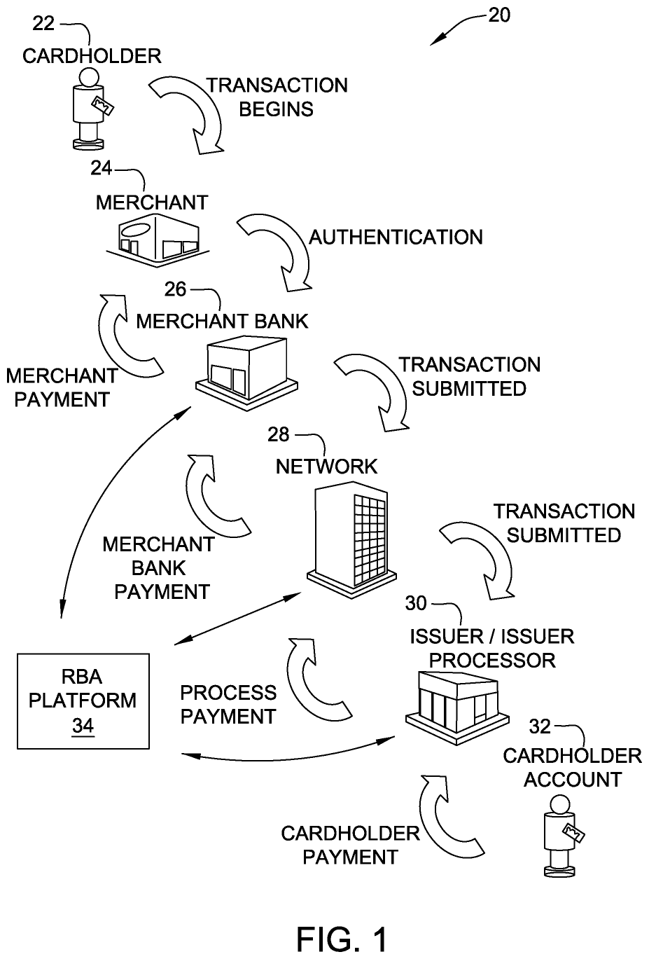

FIG. 1 is a schematic diagram illustrating an example RBA platform 34 in communication with a multi-party payment card system 20 for processing payment transactions in accordance with one embodiment of the present disclosure. FIG. 1 depicts a flow of data in a financial transaction through system 20. Embodiments described herein may relate to a transaction card system, such as a credit card payment system using the MASTERCARD® interchange network. The MASTERCARD® interchange network is a set of proprietary communications standards promulgated by Mastercard International Incorporated® for the exchange of financial transaction data and the settlement of funds between financial institutions that are licensed customers of Mastercard International Incorporated®. (MASTERCARD® is a registered trademark of Mastercard International Incorporated located in Purchase, New York).

In the exemplary transaction card system, a financial institution called the “issuer” issues a transaction card, such as a credit card, to a consumer or cardholder 22, who uses the transaction card to tender payment for a purchase from a merchant 24. Cardholder 22 may purchase goods and services (“products”) at merchant 24. Cardholder 22 may make such purchases using virtual forms of the transaction card and, more specifically, by providing data related to the transaction card (e.g., the transaction card number, expiration date, associated postal code, and security code) to initiate transactions. To accept payment with the transaction card or virtual forms of the transaction card, merchant 24 must normally establish an account with a financial institution that is part of the financial payment system. This financial institution is usually called the “merchant bank,” the “acquiring bank,” or the “acquirer.” When cardholder 22 tenders payment for a purchase with a transaction card or virtual transaction card, merchant 24 requests authentication of the cardholder 22 and authorization from a merchant bank 26 for the amount of the purchase. The request may be performed over the telephone or electronically, but is usually performed through the use of a point-of-sale terminal, which reads cardholder's 22 account information from a magnetic stripe, a chip, or embossed characters on the transaction card and communicates electronically with the transaction processing computers of merchant bank 26. Merchant 24 receives cardholder's 22 account information as provided by cardholder 22. Alternatively, merchant bank 26 may authorize a third party to perform transaction processing on its behalf. In this case, the point-of-sale terminal will be configured to communicate with the third party. Such a third party is usually called a “merchant processor,” an “acquiring processor,” or a “third party processor.”

Using an interchange network 28, computers of merchant bank 26 or merchant processor will communicate with computers of an issuer bank 30 to determine whether the alleged cardholder is actually legitimate cardholder 22 (i.e., authentication), whether cardholder's 22 account 32 is in good standing, and whether the purchase is covered by cardholder's 22 available credit line. Based on these determinations, the requests for authentication and authorization will be declined or accepted. Authentication may be performed prior to authorization. If the requests are accepted, an authorization code is issued to merchant 24.

In the exemplary embodiment, the payment card system 20 includes or is in communication with a risk-based authentication (RBA) server 34. In this embodiment, the RBA platform 34 provides enhanced meta-data collection to capture information, including meta-data from the payment transactions processed by the payment card system 20. The RBA platform 34 stores this meta-data to use to provide as historical data when performing an authentication process prior to performing an authorization process. In the exemplary embodiment, the RBA platform 34 may receive historical data from one or more of the acquirer bank 26, the interchange network 28, and the issuer bank 30. Examples of this data include one or more long term variables (“LTV”). The one or more LTV may include historical authorization data associated with a plurality of PANs, other historical data associated with the plurality of PANs, etc. The LTV may be associated with both card present and card not present historical transactions. For example, the LTV may include cardholder shipping address, cardholder billing address, cardholder email address, cardholder phone number, merchant name, merchant category, merchant location, and/or at least one environment-related variable (e.g., device details, browser details) including device ID, IP address, device channel, etc. Further, the LTV may be stored in a database accessible by RBA platform 34 and operated by an interchange network 28. In some embodiments, the LTV data will be hashed prior to storing to protect the security of this personally identifiable information.

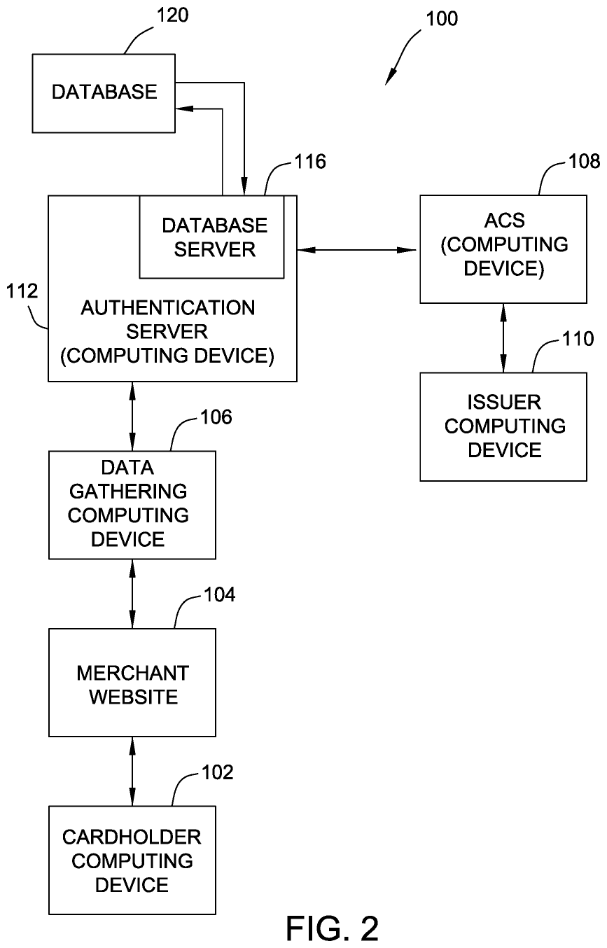

When a request for authorization is accepted, the available credit line of cardholder's 22 account 32 is decreased. Normally, a charge for a payment card transaction is not posted immediately to cardholder's 22 account 32 because bankcard companies, such as Mastercard International Incorporated®, have promulgated rules that do not allow merchant 24 to charge, or “capture,” a transaction until products are shipped or services are delivered. However, with respect to at least some debit card transactions, a charge may be posted at the time of the transaction. When merchant 24 ships or delivers the products or services, merchant 24 captures the transaction by, for example, appropriate data entry procedures on the point-of-sale terminal. This may include bundling of approved transactions daily for standard retail purchases. If cardholder 22 cancels a transaction before it is captured, a “void” is generated. If cardholder 22 returns products after the transaction has been captured, a “credit” is generated. Interchange network 28 and/or issuer bank 30 stores the transaction card information, such as a type of merchant, amount of purchase, date of purchase, in a database 120 (shown in FIG. 2).

After a purchase has been made, a clearing process occurs to transfer additional transaction data related to the purchase among the parties to the transaction, such as merchant bank 26, interchange network 28, and issuer bank 30. More specifically, during and/or after the clearing process, additional data, such as a time of purchase, a merchant name, a type of merchant, purchase information, cardholder account information, a type of transaction, information regarding the purchased item and/or service, and/or other suitable information, is associated with a transaction and transmitted between parties to the transaction as transaction data, and may be stored by any of the parties to the transaction. After a transaction is authorized and cleared, the transaction is settled among merchant 24, merchant bank 26, and issuer bank 30. Settlement refers to the transfer of financial data or funds among merchant's 24 account, merchant bank 26, and issuer bank 30 related to the transaction. Usually, transactions are captured and accumulated into a “batch,” which is settled as a group. More specifically, a transaction may be settled between issuer bank 30 and interchange network 28, and then between interchange network 28 and merchant bank 26, and then between merchant bank 26 and merchant 24.

As described below in more detail, risk-based authentication (RBA) may be performed by the RBA platform 34 on behalf of an access control server (ACS) or issuer bank 30 in the context of multi-party payment card system 20. Although the systems described herein are not intended to be limited to facilitate such applications, the systems are described as such for example purposes.

FIG. 2 is an expanded block diagram of an example embodiment of a computer system 100 used in authenticating payment transactions. In the exemplary embodiment, system 100 may be used for authenticating payment transactions either in concert with an ACS or in place of the ACS.

In the exemplary embodiment, cardholder computing devices 102 are computers that include a web browser or a software application, which enables cardholder computing devices 102 to access remote computer devices, such as merchant website 104, using the Internet or other network. More specifically, cardholder computing devices 102 may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. Cardholder computing devices 102 may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices. In the exemplary embodiment, cardholder computing devices 102 are associated with individual cardholders 22 (shown in FIG. 1).

In the exemplary embodiment, merchant website 104 is an online shopping website that is reachable through computers that include a web browser or a software application, such as cardholder computing devices 102, using the Internet or other network. More specifically, merchant website 104 may be hosted on one or more computers that are communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. Computing devices hosting merchant website 104 may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices. In the exemplary embodiment, merchant website 104 is associated with merchant 24 (shown in FIG. 1). In the exemplary embodiment, merchant website 104 allows cardholder 22 to purchase goods and/or services using cardholder computing device 102. In some embodiments, payment transactions performed through merchant website 104 are considered card not present transactions.

In the exemplary embodiment, data gathering computer devices 106 are computers that include a web browser or a software application, which enables data gathering computer devices 106 to access remote computer devices, such as merchant website 104 and authentication server 112, using the Internet or other network. More specifically, data gathering computing devices 106 may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. Data gathering computer devices 106 may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices. In some embodiments, the data gathering computer devices 106 are associated with a 3DS server or service. In other embodiments, data gathering computer devices 106 are associated with acquirer bank 26 (shown in FIG. 1).

In the exemplary embodiments, authentication server 112 is in communication with a plurality of data gathering computer devices 106 and one or more access control servers (ACS) 108. In some embodiments, authentication server 112 is similar to RBA platform 34 (shown in FIG. 1). In the exemplary embodiment, authentication server 112 receives data from data gathering computer device 106 and uses that data to perform authentication of payment transactions. In some embodiments, authentication server 112 performs authentication with ACS 108. In other embodiments, authentication server 112 replaces the ACS 108 in the authentication process. In the exemplary embodiment, authentication server 112 is associated with the interchange network 28 (shown in FIG. 1). In other embodiments, the authentication server 112 is merely in communication with the interchange network 28.

In the exemplary embodiment, issuer computing devices 110 are computers that include a web browser or a software application, which enables issuer computing devices 110 to access remote computer devices, such as ACS 108 and authentication server 112, using the Internet or other network. More specifically, issuer computing devices 110 may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. Issuer computing devices 110 may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices. In the exemplary embodiment, issuer computing devices 110 are associated with the issuer bank 30 (shown in FIG. 1).

A database server 116 is connected to database 120. In one embodiment, centralized database 120 is stored on server system 112 and can be accessed by potential users at one of client systems (not shown) by logging onto authentication server 112 through one of client systems. In an alternative embodiment, database 120 is stored remotely from authentication server 112 and may be non-centralized. Database 120 may be a database configured to store information used by authentication server 112 including, for example, historical payment transaction records.

Database 120 may include a single database having separated sections or partitions, or may include multiple databases, each being separate from each other. Database 120 may store transaction data generated over the processing network including data relating to merchants, consumers, account holders, prospective customers, issuers, acquirers, and/or purchases made. Database 120 may also store account data including at least one of a cardholder name, a cardholder address, an account number, other account identifiers, and transaction information. Database 120 may also store merchant information including a merchant identifier that identifies each merchant registered to use the network, and instructions for settling transactions including merchant bank account information. Database 120 may also store purchase data associated with items being purchased by a cardholder from a merchant, and authentication and authorization request data. Database 120 may store one or more authentication profiles, where each authentication profile includes one or more authentication rules, one or more risk level thresholds, and one or more routing rules based on the risk level thresholds.

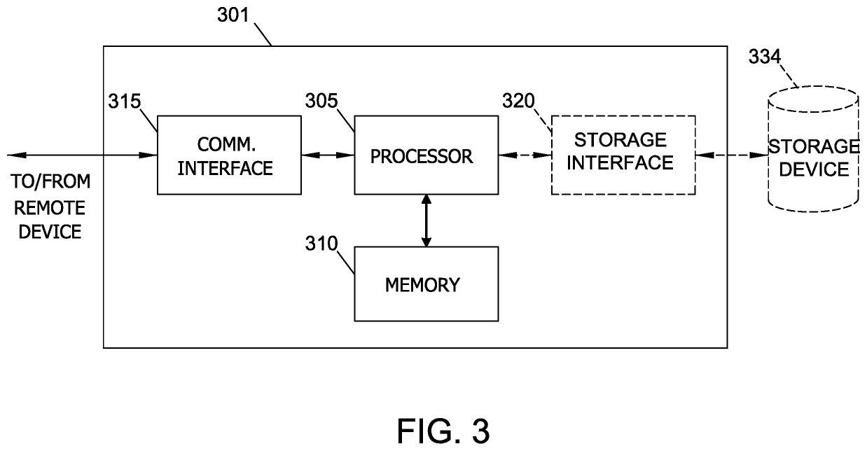

FIG. 3 illustrates an example configuration of a server system 301 such as RBA platform 34 (shown in FIG. 1), in accordance with one example embodiment of the present disclosure. Server system 301 may also include, but is not limited to, merchant website 104, data gathering computer device 106, ACS 108, issuer computing device 110, authentication server 112, and database server 116 (all shown in FIG. 2). In the example embodiment, server system 301 determines and analyzes characteristics of devices used in payment transactions, as described below.

Server system 301 includes a processor 305 for executing instructions. Instructions may be stored in a memory area 310, for example. Processor 305 may include one or more processing units (e.g., in a multi-core configuration) for executing instructions. The instructions may be executed within a variety of different operating systems on the server system 301, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C #, C++, Java, or other suitable programming languages, etc.).

Processor 305 is operatively coupled to a communication interface 315 such that server system 301 is capable of communicating with a remote device such as a user system or another server system 301. For example, communication interface 315 may receive requests from a client system (not shown) via the Internet, as illustrated in FIG. 2.

Processor 305 may also be operatively coupled to a storage device 334. Storage device 334 is any computer-operated hardware suitable for storing and/or retrieving data. In some embodiments, storage device 334 is integrated in server system 301. For example, server system 301 may include one or more hard disk drives as storage device 334. In other embodiments, storage device 334 is external to server system 301 and may be accessed by a plurality of server systems 301. For example, storage device 334 may include multiple storage units such as hard disks or solid state disks in a redundant array of inexpensive disks (RAID) configuration. Storage device 334 may include a storage area network (SAN) and/or a network attached storage (NAS) system.

In some embodiments, processor 305 is operatively coupled to storage device 334 via a storage interface 320. Storage interface 320 is any component capable of providing processor 305 with access to storage device 334. Storage interface 320 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 305 with access to storage device 334.

Memory area 310 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are examples only, and are thus not limiting as to the types of memory usable for storage of a computer program.

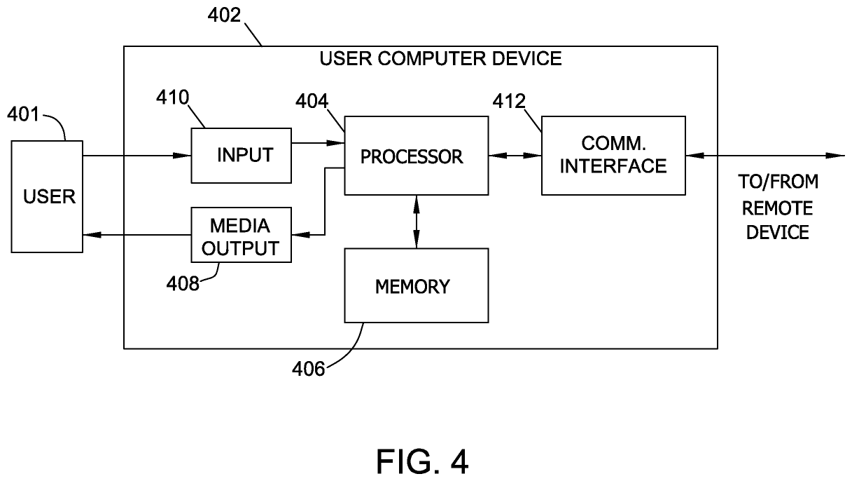

FIG. 4 illustrates an example configuration of a client computing device 402. Client computing device 402 may include, but is not limited to, cardholder computing device 102 (shown in FIG. 1). Client computing device 402 may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices. Client computing device 402 includes a processor 404 for executing instructions. In some embodiments, executable instructions are stored in a memory area 406. Processor 404 may include one or more processing units (e.g., in a multi-core configuration). Memory area 406 is any device allowing information such as executable instructions and/or other data to be stored and retrieved. Memory area 406 may include one or more computer-readable media.

Client computing device 402 also includes at least one media output component 408 for presenting information to a user 400. Media output component 408 is any component capable of conveying information to user 400. In some embodiments, media output component 408 includes an output adapter such as a video adapter and/or an audio adapter. An output adapter is operatively coupled to processor 404 and operatively couplable to an output device such as a display device (e.g., a liquid crystal display (LCD), organic light emitting diode (OLED) display, cathode ray tube (CRT), or “electronic ink” display) or an audio output device (e.g., a speaker or headphones).

In some embodiments, client computing device 402 includes an input device 410 for receiving input from user 400. Input device 410 may include, for example, a keyboard, a pointing device, a mouse, a stylus, a touch sensitive panel (e.g., a touch pad or a touch screen), a camera, a gyroscope, an accelerometer, a position detector, and/or an audio input device. A single component such as a touch screen may function as both an output device of media output component 408 and input device 410.

Client computing device 402 may also include a communication interface 412, which is communicatively couplable to a remote device such as server system 301 or a web server operated by a merchant. Communication interface 412 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)). Client computing device 402 may also be configured to support proximity payment technologies known in the art, such as near field communication (NFC).

A payment system configured for linking multiple data records to a single tokenized identifier may be configured to be executed on the client computing device 402. A user (i.e., a cardholder) may interact with a user interface of the payment system to perform payment functions. The user interface may be presented on the display device of the client computing device 402, described above. The user may input information using the input device of the client computing device 402, also described above. In some embodiments, the system may be device based (i.e., configured to be executed on a phone or other portable device) and/or web browser based (i.e., configured to be executed on any device capable of accessing the Internet).

In some embodiments, the system may be configured to take a photograph or otherwise scan a prepaid card, such as a gift card. The photograph or scan may be performed using the input device of the client computing device. For example, in some embodiments, the user interface may be configured to take a photograph of a payment card using a camera of the client computing device. Additionally or alternatively, the system may be configured to access a photograph or scan of a prepaid card. For example, the system may be configured to access a photograph or scan of a prepaid card stored on the memory of the client computing device. Additionally or alternatively, a user may interact with a user interface of the system to manually input data associated with a prepaid card. For example, the user interface may present an option for a user to manually input a sixteen digit (16) card number located on the back of a prepaid card.

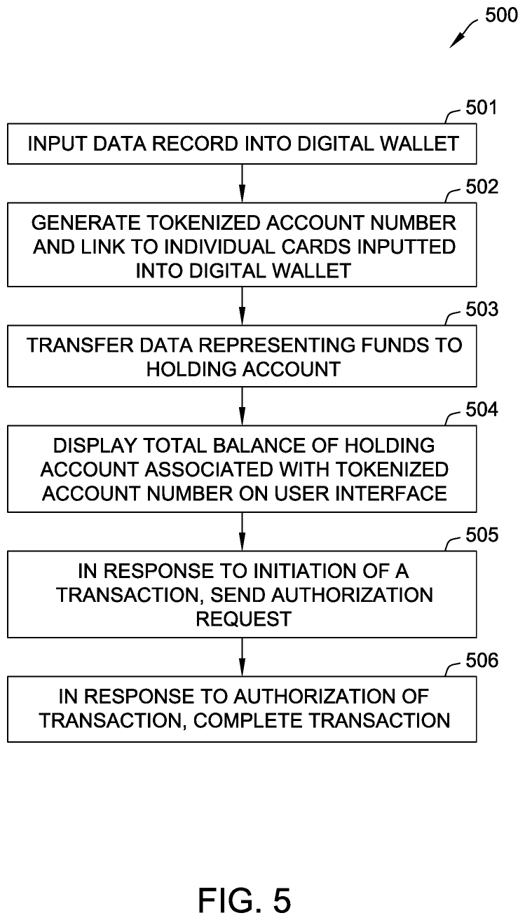

FIG. 5 is a flow diagram 500 of a first example method for linking multiple data records to a single tokenized identifier. The first step 501 may comprise inputting a data record into a digital wallet. The data record may be associated with a payment card with preloaded funds, such as a prepaid card or gift card. The payment card may be associated with a merchant and/or a payment processing company, such as MASTERCARD®. In some embodiments, the digital wallet may be an application on a portable device, such as a smartphone. Additionally, or alternatively, the digital wallet may be stored on a computer, such as a desktop computer. In some embodiments, the inputting may comprise taking a photograph of the payment card and storing the photograph in a digital wallet. The data record may be extracted from a photograph or scan of a payment card using techniques known in the art. Additionally, or alternatively, the inputting may comprise manually inputting a code or other data into the digital wallet. In some embodiments, the data record may include the amount or value of a payment card, whether the payment card is tied to one or more merchants or payment processors, and/or whether there are any predefined rules associated with card. In some embodiments, the predefined rules may be determined based on a lookup or application programming interface (API) call to a rules database. If there are predefined rules associated with the payment card, the predefined rules are retrieved upon initiation of the transaction so the system may determine whether the payment card may be used to perform the transaction.

Once a data record has been inputted into the digital wallet, the wallet may generate a tokenized account number, or token primary account number (PAN) at 502. In some embodiments, the token PAN may represent an actual account number that may be used to initiate a payment card transaction. The token PAN may provide a secure transaction in that it does not expose the actual account number to data breaches and fraudsters, as it is tokenized. Also at 502, the token PAN may then be linked to the one or more payment cards that are inputted into the wallet. Stated another way, when the token PAN is used to initiate a payment transaction, the token PAN may be transmitted to complete the payment. The token PAN may be linked to the back end of each of the payment cards and configured to use the available funds of the payment cards linked to the token PAN to complete the purchase.

The token PAN may include fraud detection services associated with or used for each transaction with the token PAN that cannot be performed with prepaid cards on their own. For example, if the token PAN is used multiple times to initiate multiple transactions, the metadata associated with each transaction, such as device data, IP address, shipping address, etc., may all be stored and used to compare to other transactions. The system may determine a likelihood of fraud based on risk-based authentication (RBA) and/or risk based decisioning (RBD). For example, if the metadata associated with a transaction matches that of a user, the system may determine that those transactions are likely not a result of fraud. The transaction may then be performed with no further authentication steps (e.g., challenge questions, verification code, etc.). However, if the metadata does not match that of a user (e.g., an IP address that is not associated with the user, the transaction is being initiated in a different country than the location of the transaction), then the RBA/RBL module may score this transaction as a strong likelihood of fraud and in some instances be denied by the system. A message may be sent to the merchant and/or issuer to deny the transaction. The ability to monitor the token PAN and apply an RBA/RDL module to transactions dramatically improves the likelihood that a transaction is being performed by the legitimate user.

In the embodiment of FIG. 5, when a data record associated with a payment card is inputted into the digital wallet, any prepaid funds associated with the payment card may be immediately moved to an account associated with the token PAN at 503, such that the prepaid funds are immediately secured in an account associated with the user. For example, if a payment card with prepaid funds is loaded into the digital wallet, data representing the available funds of the payment card may be immediately transferred from a first issuing bank associated with the payment card to a holding account. In some embodiments, the holding account may be accessed via the token PAN. In some embodiments, the token PAN may be used up to the collective total value of all of the prepaid funds of payment cards loaded into the digital wallet and linked to the token PAN, regardless of the merchants and/or payment processing companies associated with the payment cards.

At 504, the user may view the value of the combination of the prepaid cards associated with the token PAN on the user interface. For example, the total value of the combination of the prepaid cards may be shown on the display device of the client computing device. In some embodiments, the combination of the plurality of payment cards may be represented on a user interface with digital card art and the last four (4) digits of the token PAN.

A transaction may be initiated by submitting the token PAN. In response to the initiation of a transaction, an authorization message may then be created and include the token PAN, as well as other data, such as metadata, at 505. Since the token PAN is associated with a single holding account, the transaction only needs to be authorized by the bank associated with the holding account of the token PAN. This simplifies not only the authorization process, but the subsequent settlement and clearing processes as well. In response to authorization of the transaction, the transaction may be completed at 506.

If the transaction is being completed in-person, the purchase may be completed via NFC or any other proximity payment technology known in the art. For example, in some embodiments, the user may complete a transaction by tapping their phone or other portable device near a point-of-sale terminal equipped with the necessary proximity payment technology. If the transaction is being completed online, the user may open the digital wallet and complete the purchase by interacting with the user interface. In some embodiments, the user may be given an option to access the token PAN to complete the transaction. Once a transaction is completed, the total remaining balance of the holding account associated with the token PAN is updated and the updated total collective amount is displayed on the user interface.

Payment cards may be inputted into the digital wallet at any time. For example, a user may load one or more prepaid cards into a digital wallet associated with a token PAN after the token PAN has been established and data representing funds associated with the new prepaid card may be transferred from the respective issuing banks to the token PAN account. The new collective total associated with the token PAN account may be updated and displayed on the user interface.

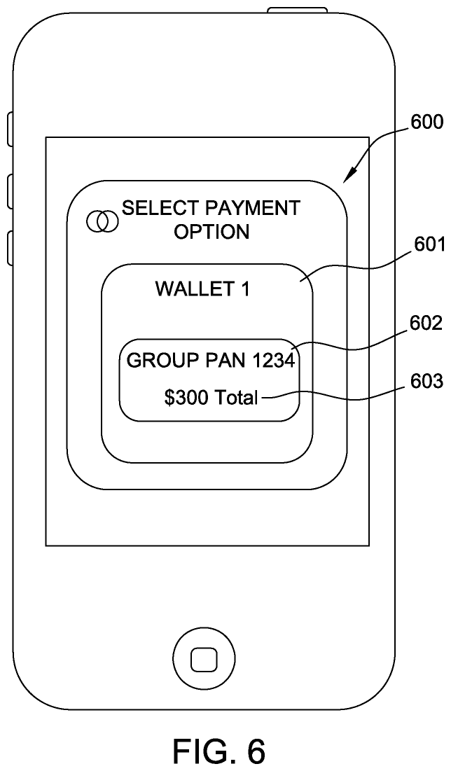

FIG. 6 is a diagram 600 illustrating a first user display associated with the first example method of FIG. 5. The user interface 600 may be displayed on a display of the client computing device 402 (shown in FIG. 4). In the embodiment illustrated in FIG. 6, the payment cards are loaded into digital wallet 601 and linked to a token PAN. The payment cards linked to the token PAN may be displayed as a single digital card 602. In some embodiments the single digital card may be displayed with at least a portion of the account number of the token PAN. In the embodiments of FIGS. 5 and 6, any available prepaid funds of the one or more payment cards linked to the token PAN are immediately transferred to a holding account associated with the token PAN, and therefore a collective value of the prepaid funds may be used, as discussed above. As such, in some embodiments, the collective total of the plurality of prepaid cards may be displayed on the user interface 600. After a transaction with the token PAN has been completed or a new payment card has been linked to the token PAN, the collective total value of the token PAN (e.g., “$300 Total” 603 in FIG. 6) may be updated on the user interface.

In some embodiments, a token PAN may be further linked to an account associated with more traditional forms of payment, such as a general purpose credit or debit card or bank account. This account may be used to cover any amounts spent over the total amount of the prepaid cards linked to the token PAN. Stated another way, the account may be used as a shortfall funding source to make up any difference between the transaction amount and the sum total of the linked payment cards with prepaid funds to ensure no transaction failures for the token PAN (assuming the back-up account can cover the group in transaction amount).

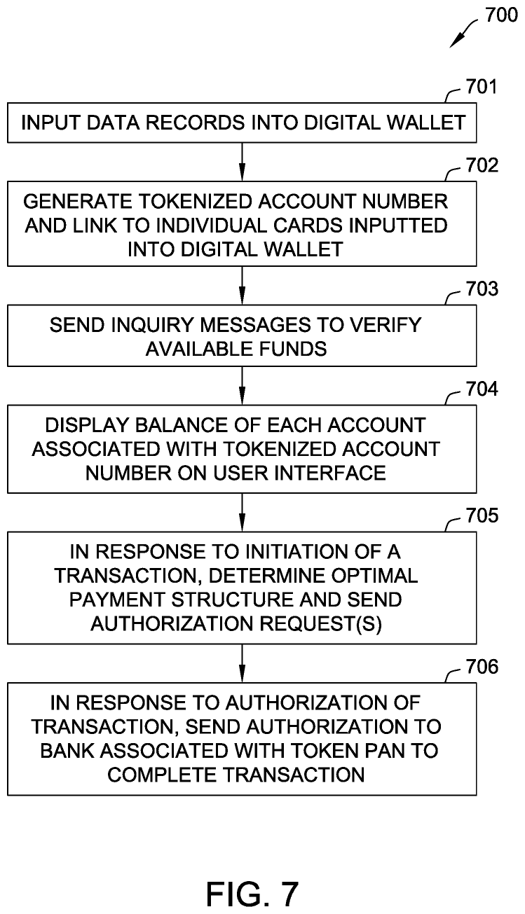

FIG. 7 is a flow diagram 700 of a second example method for linking multiple data records to a single tokenized identifier. The first step 701 may comprise inputting a data record into a digital wallet. The data record may be associated with a payment card with preloaded funds (i.e., a prepaid card or gift card). The payment card may be associated with a merchant and/or a payment processing company, such as MASTERCARD®. In some embodiments, the digital wallet may be an application on a portable device, such as a smartphone. Additionally, or alternatively, the digital wallet may be stored on a computer, such as a desktop computer. In some embodiments, the inputting may comprise taking a photograph of the payment card and storing the photograph in a digital wallet. The data record may be extracted from a photograph or scan of a payment card using techniques known in the art. Additionally, or alternatively, the inputting may comprise manually inputting a code or other data into the digital wallet. In some embodiments, the data record may include the amount or value of a payment card, whether the payment card is tied to one or more merchants or payment processors, and/or whether there are any predefined rules associated with card. In some embodiments, the predefined rules may be determined based on a lookup or application programming interface (API) call to a rules database. If there are predefined rules associated with the payment card, the predefined rules are retrieved upon initiation of the transaction so the system may determine whether the payment card may be used to perform the transaction, as described in further detail below.

Once a data record has been inputted into the digital wallet, the wallet may generate a tokenized account number, or token primary account number (PAN) at 702. In some embodiments, the token PAN may represent an actual account number that may be used to initiate a payment card transaction. The token PAN may provide a secure transaction in that it does not expose the actual account number to data breaches and fraudsters, as it is tokenized. The token PAN may then be linked to the one or more payment cards that are inputted into the wallet at 702. Stated another way, when the token PAN is used to initiate a payment transaction, the token PAN may be transmitted to complete the payment. The token PAN may be linked to the back end of each of the payment cards and configured to use one or more of the payment cards linked to the token PAN to complete the purchase. In some embodiments, the data records linked to the token PAN may be tokenized by providing detokenization and dynamic data or cryptography validation for one or more of near field communication (NFC) contactless payments, dynamic magnetic stripe data payments, digital secure remote payments (including in-app, browser, and card-on-file), and dynamic token verification codes. Tokenization of the data records may improve security of stored account information, as discussed in more detail below.

The token PAN may include additional fraud detection services associated with or used for each transaction with the token PAN that cannot be performed with prepaid cards on their own. For example, if the token PAN is used multiple times to initiate multiple transactions, the metadata associated with each transaction, such as device data, IP address, shipping address, etc., may all be stored and used to compare to other transactions. The system may determine a likelihood of fraud based on risk-based authentication (RBA) and/or risk based decisioning (RBD). For example, if the metadata associated with a transaction matches that of a user, the system may determine that those transactions are likely not a result of fraud, i.e., the user is likely the legitimate cardholder is initiating the transaction. The transaction may then be performed with no further authentication steps (e.g., challenge questions, verification code, etc.). However, if the metadata does not match that of a user (e.g., an IP address that is not associated with the user, the transaction is being initiated in a different country than the location of the transaction), then the RBA/RBD module may score this transaction as a strong likelihood of fraud and in some instances be denied by the system. A message may be sent to the merchant and/or issuer to deny the transaction. The ability to monitor the token PAN and apply an RBA/RBD module to transactions dramatically improves the likelihood that a transaction is being performed by the legitimate cardholder and is not fraudulent.

In some embodiments, the token domain restriction controls may be applied that are unique to the token PAN associated with the payment card. For example, if a user attempts to use a payment card that is linked to a token PAN in any way other than via the token PAN (e.g., swiping the gift card at a point-of-sale terminal of a merchant), data representing funds will not be transferred from the issuing bank. As such, tokenization of the prepaid cards may prevent fraudulent transactions to successfully proceed.

Once a data record is inputted, it may be displayed in a digital wallet application or website at 704. In some embodiments, the display will show a user how the amount or value associated with the respective payment card, whether the payment card is tied to a merchant or payment processor, and/or if there are any predefined rules or other parameters associated with the payment card (e.g., loyalty points, expiration date, etc.). In some embodiments, a user may be able to activate and deactivate payment cards in the digital wallet. If a payment card is activated, the payment card may be used if all rules are satisfied for use in a transaction. If a payment card is deactivated, the payment card may not be used, even if all rules are satisfied for use in a transaction.

In some embodiments, for example at 703, an inquiry message is immediately sent when a data record associated with a payment card is inputted into the digital wallet. The inquiry message may verify the amount of prepaid funds available, the data record associated with the payment card has not been compromised, etc. More particularly, inquiry messages are sent to each issuer bank of each of the payment cards, to verify the amount of prepaid funds available, the data record associated with the payment card has not been compromised, etc. The balance may be verified using application programing interfaces (APIs), balance enquiry ISO messages, or any other verification method known in the art. In some embodiments, inquiry messages may be sent periodically to determine the available balance of each of the prepaid cards linked to a token PAN and the available balance of each of the prepaid cards linked to the token PAN may be updated on a user interface. The inquiry messages may help manage fraud or simple cardholder error related to the physical prepaid cards.

In the second example method, data representing the available funds of each of the cards may remain in the issuer bank associated with the payment card. For example, if a payment card is loaded into the digital wallet associated with a token PAN, the data representing funds associated with the payment card remains in the issuer bank associated with that payment card. When a user seeks to tender payment for a purchase with the token PAN, the merchant may request authentication of the cardholder and authorization from each of the issuer banks associated with each of the payment cards linked to the token PAN and being used for the purchase for the amount of the purchase. As such, to the merchant it would appear as a single transaction, but at the network level it would be a “split sale”. An algorithm comprising predefined rules may be used at a network level to determine the optimal use of the cards available and their available balances to complete the transaction, as discussed in more detail below. In some embodiments, the optimal use of the cards determined by the algorithm comprises using the full available balance on as many of the prepaid cards as possible. In embodiments where inquiry messages are sent periodically to determine the available balance of each of the prepaid cards linked to a token PAN, the available balance of each of the prepaid cards linked to the token PAN may be updated on a user interface.

A transaction may be initiated by submitting the token PAN. An authorization message may then be created and include the token PAN, as well as other data, such as the merchant ID, the product amount, etc., along with metadata. The system may then retrieve and apply predefined rules associated with the merchant ID. The payment processor may identify that the token PAN is being used and may determine how the transaction will be structured at 705. The payment processor may then save how the transaction was structured as a data record. The payment processor may send one or more authorization messages depending on the number of payment cards being used in a transaction. For example, in some cases the payment processor may determine that the transaction will be split between a first account and a second account, where the first account is associated with a prepaid card, according to an embodiment. The payment processor may then send a first authorization request to a first bank associated with the first account and a second authorization request to a second bank associated with the second account. Once the two banks authorize the transaction, the payment processor may then send an authorization message to the bank associated with the token PAN so the merchant bank knows to complete the transaction, and the transaction is then finalized at 706. Once a transaction is completed, the remaining balance of each of the individual prepaid cards linked to the token PAN may be updated and displayed on the user interface.

The structure of the transaction may be determined using the predefined rules and other data associated with the payment cards linked to the token PAN. For example, expiration dates, the merchant of the transaction, an amount or value of prepaid funds of each of the payment cards, etc., may be considered when determining how the transaction will be structured. For example, if there are two payment cards with prepaid funds available for a merchant, and a transaction is being conducted at that merchant, the payment processor may determine that the payment card with the earlier expiration date should be used in a transaction. In another example, the merchant of the transaction may be considered. The payment processor may determine that a payment card associated with that particular merchant should be used and not a general prepaid card associated with a payment processing company. In yet another example, the payment processor may determine that a structure in which a full balance of as many payment cards as possible is used. Therefore, the payment processor may determine that two payment cards with lower available balances should be used for a transaction, instead of another payment card which could cover the full balance. This may reduce the complexity of the token PAN by minimizing the number of payment cards linked to the token PAN.

If the transaction is being completed in-person, the purchase may be completed via NFC or any other proximity payment technology known in the art. For example, in some embodiments, the user may complete a transaction by tapping their phone or other portable device near a point-of-sale terminal equipped with the necessary proximity payment technology. If the transaction is being completed online, the user may access the token PAN information and complete the purchase by interacting with the user interface. In some embodiments, the user may be given an option to access the token PAN to complete the transaction. Once a transaction is completed, respective values of the payment cards linked to the token PAN may be updated on the user interface.

In some embodiments, a token PAN may be further linked to an account associated with more traditional forms of payment, such as a general purpose credit or debit card or bank account. This account may be used to cover any amounts spent over the total amount of the payment cards linked to the token PAN. Stated another way, the account may be used as a shortfall funding source to make up any difference between the transaction amount and the sum total of the linked payment cards with prepaid funds to ensure no transaction failures for the token PAN (assuming the back-up account can cover the group in transaction amount).

In some embodiments, the token PAN may facilitate deals between two or more merchants. For example, in some embodiments, one or more agreements between merchants may be applied when the token PAN is used for a purchase. The agreements may stipulate rules that allow the digital wallet to convert a payment card from one merchant to another merchant. For example, a first merchant and a second merchant may have a bilateral agreement in place in which a payment card associated with the first merchant may be used for purchases at the second merchant, and vice-vera. The agreement may specify conditions, for example, a payment card associated may only have five (5) dollars or less available in order to be used at the other merchant.

In some embodiments, a user may still receive loyalty points and/or rewards associated with a merchant or merchants when the token PAN is used to tender payment for a purchase from a merchant. For example, if the token PAN is used to tender payment for a purchase from a merchant that offers loyalty points, the user may still receive the loyalty points offered by a merchant.

Payment cards may be inputted into the digital wallet at any time. For example, a user may load one or more prepaid cards into a digital wallet associated with a token PAN after the token PAN has been established and the available funds of the new payment card may be displayed on the user interface.

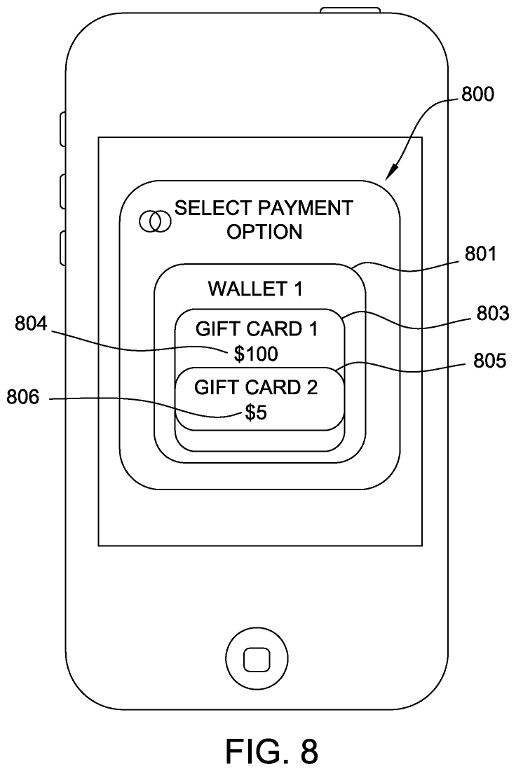

FIG. 8 is a diagram illustrating a second user display 800 associated with the second example method of FIG. 7. The user interface may be displayed on a display of the client computing device 402 (shown in FIG. 4). In the embodiment illustrated in FIG. 8, the payment cards are loaded into digital wallet 801 and linked to a token PAN. Each of the payment cards linked to the token PAN may be represented as a digital card, e.g., “Gift Card 1” 803 and Gift Card 2” 805. In some embodiments, an amount of value of prepaid funds stored on each payment card linked to the token PAN may be displayed on a user interface, for example, one-hundred dollars ($100) 804 on “Gift Card 1” 803 and five dollars ($5) 806 on “Gift Card 2” 805.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

This written description uses examples to disclose the disclosure, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computer-implemented method for linking multiple data records to a single tokenized identifier, the method implemented using a computing system including at least one processor and a memory device, the method comprising steps performed by the at least one processor of:
receiving a first data record associated with a first account into a digital wallet and a second data record associated with a second account into the digital wallet, wherein the first account is associated with a prepaid card;
generating a token primary account number (PAN) and linking the first data record and the second data record;
sending an inquiry message to a first bank associated with the first account to verify available funds of the first account;
causing to be displayed on a user interface, the available funds of the first account;
in response to initiation of a transaction, determining an optimal payment structure based on the available funds of the first account, and sending a first authorization request to a first bank associated with the first account and a second authorization request to a second bank associated with the second account based on the optimal payment structure; and
in response to authorization of the transaction from the first bank and the second bank, sending an authorization message to a bank associated with the token PAN.

2. The computer implemented method of claim 1, wherein the data record further includes predefined rules associated with the first account and further comprising, in response to the initiation of the transaction, retrieving the predefined rules to determine the first account may be used to perform the transaction.

3. The computer-implemented method of claim 1, further comprising saving the optimal payment structure as a data record in the memory device.

4. The computer-implemented method of claim 1, wherein the second account is associated with a general purpose payment card.

5. The computer-implemented method of claim 1, further comprising, in response to the initiation of the transaction, determining a likelihood of fraud based on at least one of risk-based authentication (RBA) and risk based decisioning (RBD).

6. The computer implemented method of claim 1, further comprising placing token domain restriction controls on the token PAN.

7. The computer implemented method of claim 1, further comprising, in response to a user input, deactivating the first account or second account.

8. A computing system for linking multiple data records to a single tokenized identifier, said computing system comprising at least one processor and a memory device, said at least one processor programmed to perform steps including:
receiving a first data record associated with a first account into a digital wallet and a second data record associated with a second account into the digital wallet, wherein the first account is associated with a prepaid card;
generating a token primary account number (PAN) and linking the first data record and the second data record;
sending an inquiry message to a first bank associated with the first account to verify available funds of the first account;
causing to be displayed on a user interface, the available funds of the first account;
in response to initiation of a transaction, determining an optimal payment structure based on the available funds of the first account, and sending a first authorization request to a first bank associated with the first account and a second authorization request to a second bank associated with the second account based on the optimal payment structure; and
in response to authorization of the transaction from the first bank and the second bank, sending an authorization message to a bank associated with the token PAN.

9. The computing system of claim 8, wherein the data record further includes predefined rules associated with the first account and the at least one processor is further programmed to, in response to the initiation of the transaction, retrieve the predefined rules to determine the first account may be used to perform the transaction.

10. The computing system of claim 8, wherein the optimal payment structure is stored as a data record in the memory device.

11. The computing system of claim 8, wherein the second account is associated with a general purpose payment card.

12. The computing system of claim 8, wherein the at least one processor is further programmed to, in response to the initiation of the transaction, determine a likelihood of fraud based on at least one of risk-based authentication (RBA) and risk based decisioning (RBD).

13. The computing system of claim 8, wherein the at least one processor is further programmed to place token domain restriction controls on the token PAN.

14. The computing system of claim 8, wherein the at least one processor is further programmed to, in response to a user input, deactivate the first account or second account.

15. At least one non-transitory computer-readable medium comprising instructions stored thereon for linking multiple data records to a single tokenized identifier, the instructions executable by at least one processor to cause the at least one processor programmed to perform steps including:
receiving a first data record associated with a first account into a digital wallet and a second data record associated with a second account into the digital wallet, wherein the first account is associated with a prepaid card;
generating a token primary account number (PAN) and linking the first data record and the second data record;
sending an inquiry message to a first bank associated with the first account to verify available funds of the first account;
causing to be displayed on a user interface, the available funds of the first account;
in response to initiation of a transaction, determining an optimal payment structure based on the available funds of the first account, and sending a first authorization request to a first bank associated with the first account and a second authorization request to a second bank associated with the second account based on the optimal payment structure; and
in response to authorization of the transaction from the first bank and the second bank, sending an authorization message to a bank associated with the token PAN.

16. The at least one non-transitory computer-readable medium according to claim 15, wherein the data record further includes predefined rules associated with the first account and said instructions further cause the at least one processor to, in response to the initiation of the transaction, retrieve the predefined rules to determine the first account may be used to perform the transaction.

17. The at least one non-transitory computer-readable medium according to claim 15, wherein the optimal payment structure is stored as a data record in the memory device.

18. The at least one non-transitory computer-readable medium according to claim 15, wherein the second account is associated with a general purpose payment card.

19. The at least one non-transitory computer-readable medium according to claim 15, wherein said instructions further cause the at least one processor to, in response to the initiation of the transaction, determine a likelihood of fraud based on at least one of risk-based authentication (RBA) and risk based decisioning (RBD).

20. The at least one non-transitory computer-readable medium according to claim 15, wherein said instructions further cause the at least one processor to, place token domain restriction controls on the token PAN.
